(19) United States
(12) Patent Application Publication
(10) Pub. No.: US 2025/0390810 A1
(43) Pub. Date: Dec. 25, 2025

(54) SYSTEM AND METHOD FOR ENABLING TRUE-TO-INTERVAL ANALYTICS IN AN AUTOMATIC CONTACT DISTRIBUTOR APPLICATION

(71) Applicant: NICE LTD., Ra'anana (IL)

(72) Inventors: Niranjan BAGADE, Pune (IN); Nick MARTIN, Plano, TX (US); Kanchan VASNANI, Indore (IN)

(21) Appl. No.: 18/747,517

(22) Filed: Jun. 19, 2024

(51) Int. Cl. G06Q 10/0631

(52) U.S. Cl. CPC G06Q 10/06311

(57) ABSTRACT

A computerized-method for enabling true-to-interval analytics from an ACD-application. The computerized-method includes during a shift-schedule having time-intervals, (i) for each time-interval, a. every preconfigured time-period in the time-interval: i. polling data-feed from the ACD-application; and ii. obtaining true-to-interval parameters from the polled data-feed and storing the true-to-interval parameters with start-time of the preconfigured time-period. The true-to-interval parameters include for each contact: 1) a state of activity; 2) handle-time duration; and 3) hold-time duration. b. calculating number of contacts having the activity state, based on the true-to-interval parameters; c. calculating total interval-handle-time and total interval-hold-time for each contact; (ii) calculating total handle-time for all contacts during the time-interval; and (iii) retrieving the calculated total handle-time and total hold-time of each time-interval and a total handle-time of one or more shift-schedules from the tti-database and transmitting it to a WFM application, over a communication channel to enable the WFM application true-to-interval analytics.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of computerized systems and methods for enabling true-to-interval analytics from an Automatic Contact Distributor (ACD) application.

### BACKGROUND

The “True to Interval Paradigm” refers to a concept in workforce management, in contact centers. The True to Interval (TTI) analytics, aims to improve the accuracy of forecasting and scheduling by reporting activities in the time intervals when they actually occur, rather than once they start or end. Interval reports which are provided by Working Management (WFM) applications, highlight time-intervals where things might not have been going as smoothly as they appeared when calculating daily averages. For example, in a contact center, if the Average Speed of Answer (ASA) for a day has been calculated as 25 seconds, an interval reports may reveal that during the time-interval of lunchtime, the ASA has increased to 5 minutes. This spike of 5 minutes had influenced the ASA calculation and future schedule might be less accurate if the staffing requirements are not adjusted to reflect that one-time spike.

In existing systems in contact centers, staffing requirements are calculated by counting a work item either at the beginning or at the end of an interaction with a contact, hence they count work items only once, i.e., either at the end of the contact or at the beginning and measure time as opposed to activity. The single count of a work item, whether at the beginning or the end of the interaction, are inherently erroneous assumptions, that lead to inaccuracies in staffing requirement calculations. Since agent schedules are generated based on the staffing requirements, these inaccuracies impact agent assignments and hence would impact the operations of the contact center.

Importing historical data of agents volume and performance during shifts is a necessary function for a WFM application to generate a forecast of staffing requirements.

In existing systems in contact centers, the implemented paradigm is When Contact Ended (WCE) which calculates the Average Handle Time (AHT) at the end of the planning time-interval in which the work has been performed and use it for future staffing requirements predictions.

The True to Interval (TTI) paradigm addresses the need for more accurate work planning, especially for digital interactions which may be take longer time with plural breaks, unlike phone calls. It deconstructs contacts into activity-based work history. There is a need for a technical solution that will normalize work planning to the smallest time-interval and consider the number of work items received and active therewithin, thus, improving the calculations of staffing requirements which are used during scheduling of agents via WFM applications. For example, by identifying a piece of work being handled within a contact.

Therefore, there is a need for a technical solution that will provide a method and an end-to-end system to address the inaccuracies of current practices and wouldn't require a critical design enhancement to the Automatic Contact Distributor (ACD) application. There is a need for a mechanism to ingest data from ACD applications without such enhancements.

There is a need for a technical solution that will convert data received from ACD applications which currently includes time-based work item-handling to data that is activity-based measurements to be consumed by a WFM system.

### SUMMARY

There is thus provided, in accordance with some embodiments of the present disclosure, a computerized-method for enabling true-to-interval analytics from an Automatic Contact Distributor (ACD) application.

In accordance with some embodiments of the present disclosure, the computerized-method may include during a shift-schedule having one or more time-intervals, (i) calculating total interval-handle-time and total interval-hold-time for each time-interval, every preconfigured time-period in the time-interval: a. polling data-feed from the ACD application; and b. obtaining true-to-interval parameters from the polled data-feed and storing the true-to-interval parameters with start-time of the preconfigured time-period, in a tti-database. The true-to-interval parameters include for each contact: 1) a state of activity; 2) handle-time duration; and 3) hold-time duration, (ii) at the end of the time-interval, calculating number of contacts having the activity state, based on the true-to-interval parameters in the tti-database; (iii) storing the total interval-handle-time and total interval-hold-time in the tti-database; (iv) calculating total handle-time for all contacts during the time-interval, and storing the total handle-time for all contacts in the tti-database; (v) repeating operations (i)-(iv) for each time-interval in the shift-schedule; and (vi) retrieving the calculated total handle-time and total hold-time of each time-interval and a total handle-time of one or more shift-schedules from the tti-database and transmitting it to a Workforce Management (WFM) application, over a communication channel to enable the WFM application true-to-interval analytics.

Furthermore, in accordance with some embodiments of the present disclosure, the state of activity is at least one of: (a) ‘received’; (b) ‘answered’; (c) ‘active’; and (d) ‘hold’.

Furthermore, in accordance with some embodiments of the present disclosure, the total interval-handle-time for each contact may be calculated based on time that the contact has ‘active’ state during the time-interval, and the total interval-hold-time for each contact may be calculated based on time that the contact has ‘hold’ state during the time-interval.

Furthermore, in accordance with some embodiments of the present disclosure, the total handle-time of each shift-schedule in the one or more shift-schedules may be calculated by summing the total handle-time for all contacts during the one or more time-intervals of the shift-schedule.

Furthermore, in accordance with some embodiments of the present disclosure, the computerized-method may further include configuring a Workforce Management (WFM) application to generate a forecast for a period having one or more future-schedules base on the transmitted total handle-time and total hold-time of each time-interval and the total handle-time for each contact of one or more shift-schedules.

Furthermore, in accordance with some embodiments of the present disclosure, the computerized-method may further include displaying the generated forecast for the period via a User interface (UI) that is associated to the WFM application and upon user-click on an icon on the UI, automatically sending a notification of the generated forecast to a computerized-device of a user, for review.

Furthermore, in accordance with some embodiments of the present disclosure, the forecast for the period may include agents requirement for each future-time-interval in each future-schedule in the one or more future-schedules.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1C schematically illustrate a high-level diagram of a computerized-system for enabling true-to-interval analytics from an Automatic Contact Distributor (ACD) application, in accordance with some embodiments of the present invention;

FIGS. 2A-2B schematically illustrate a high-level diagram of a module for enabling true-to-interval analytics from an Automatic Contact Distributor (ACD) application, in accordance with some embodiments of the present invention;

FIG. 3 schematically illustrates calculation of agents requirements before and after enabling true-to-interval analytics from an Automatic Contact Distributor (ACD) application, in accordance with some embodiments of the present invention;

FIG. 4 schematically illustrates a graph of comparison of staff requirements prediction, in accordance with some embodiments of the present invention;

FIG. 5 schematically illustrates extractor and transformer service, in accordance with some embodiments of the present invention;

FIG. 6 schematically illustrates a high-level diagram of a computerized-method for enabling true-to-interval analytics from an Automatic Contact Distributor (ACD) application, in accordance with some embodiments of the present invention; and

FIGS. 7A-7D are examples of operation of a module for enabling true-to-interval analytics from an Automatic Contact Distributor (ACD) application, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current contact centers, asynchronous interactions may be handled via digital channels, such as emails and chats. For example, where there may be a delay between responses of the agent to the customer and vice versa. These may also be long handle time interactions which exceed a preconfigured time-interval in the contact center and may span across two or more interactions.

As per the current industry-standard practice, staffing requirements are based on calculations on data history, which are counting the work-item either at the beginning or at the end of a handled contact, thus, counting the work items only once, i.e., either at the end of the contact or at the beginning and measure time as opposed to activity. This single count of a work-item is an inherently erroneous assumption that leads to inaccuracies in staffing requirement calculations for future schedules. As the agent schedules are generated based on history data of staffing requirements and performance, these inaccuracies impact agents assignments for future schedules and hence impact the operations of the contact center.

In existing ACD applications that support the true-to-interval approach, there are several deficiencies. One deficiency is that the data history for future staffing requirements, is reported in the time-interval when the contact ended and is distributed as the work volume following the end of the contact, rather than the prior time-interval when the work has occurred. This is a mistake as it projects work volume into periods that have no association with the time that the work has been performed. Another deficiency is that a work volume is evenly distributed into the following contiguous time-intervals. This does not consider the asynchronous nature of certain digital channels where actual work items may be spread over the course of several time-intervals and have periods of delays or interruptions. Lastly, Erlang C is a mathematical formula used in contact centers to calculate the number of agents needed to handle incoming interaction while maintaining a specific service level, but their method forces a user to a simple workload calculation from Erlang C, which considers service objectives, such as service level or ASA which adds additional staffing requirement to the workload. Various SLA targets, such as ASA, are defined and taken as an input at the time of generating the staffing requirements. Schedules generated using these staffing requirements have to meet these service targets.

Therefore, there is a need for a technical solution or a mechanism that will ingest data from ACD applications without an enhancement to the ACD application to support the True-to Interval paradigm. There is a need for a technical solution that will convert data from the ACD application which includes time-based work item-handling to activity-based measurements, to be consumed by a WFM system designed to receive event analysis data, such that the WFM may receive true to interval data regardless of the time-based work item-handling data received from the ACD application.

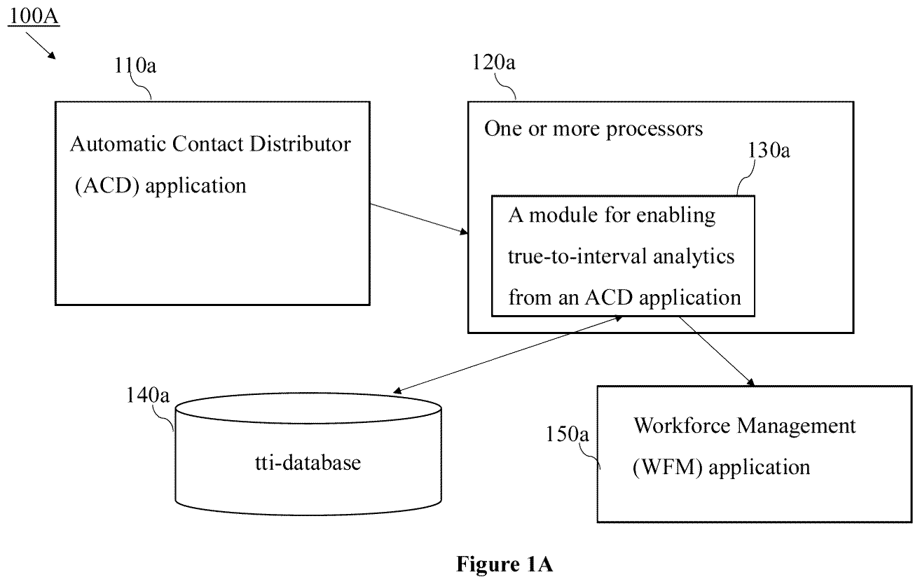

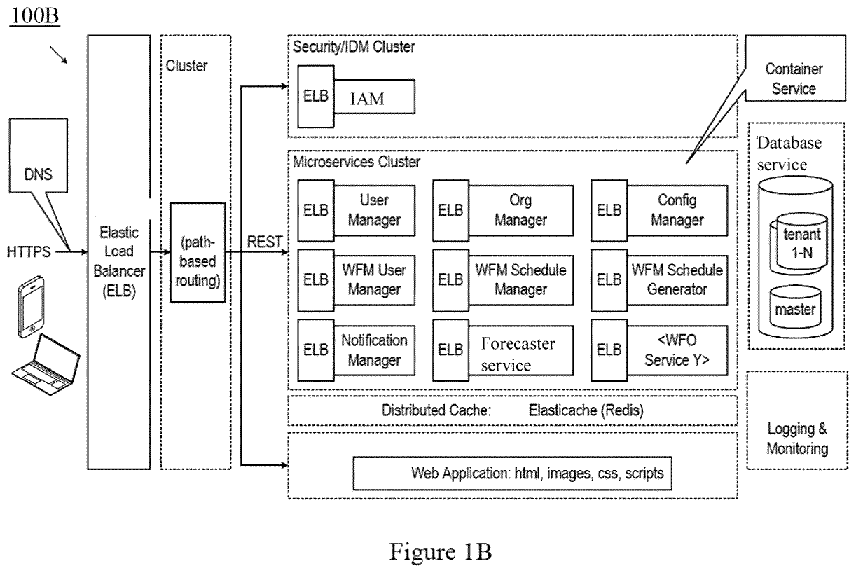

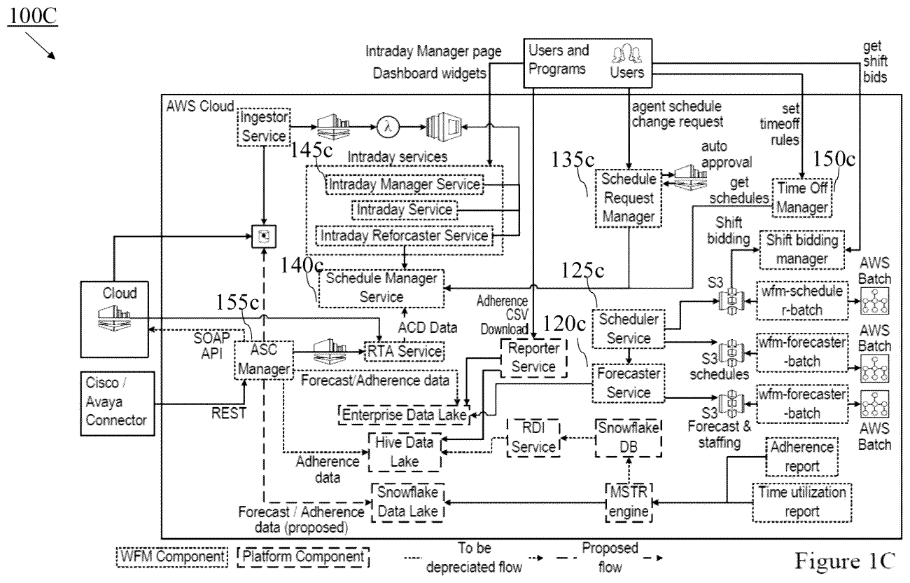

FIG. 1A schematically illustrates a high-level diagram of a system 100A for enabling true-to-interval analytics from an Automatic Contact Distributor (ACD) application, in accordance with some embodiments of the present invention.

According to some embodiments of the present disclosure, a system, such as system 100A may implement a computerized-method for enabling true-to-interval analytics from an Automatic Contact Distributor (ACD) application, via a module, such as module for enabling true-to-interval analytics from an Automatic Contact Distributor (ACD) application 130a.

According to some embodiments of the present disclosure, system 100A may transform or convert data-feed from a non-true-to-interval ACD application to a true-to-interval compatible data-feed to support the true-to-interval paradigm in the WFM application 150a.

According to some embodiments of the present disclosure, system 100A may provide a mechanism to construct time-to-interval data from different types of ACD applications, which can be consumed by the WFM application 150a, that implement time-to-interval paradigm for automated schedule generation, thereby extending the scope of implementing a system for staff requirement computation for synchronous and asynchronous work-items, by supporting different ACD application types.

According to some embodiments of the present disclosure, one or more processors 120a may be configured to operate a module for enabling true-to-interval analytics from an ACD application 130a may poll data feed from an ACD application 110a at an interval of {x} minutes, where {x} may be a configurable parameter which defines the interval of polling the data-feed from the ACD application 110a.

According to some embodiments of the present disclosure, true-to-interval parameters may be obtained from the polled data-feed which are required for supporting the true-to-interval paradigm by the WFM application 150. For example, as described in U.S. patent application Ser. No. 18/055,694 “Staff requirement computation for synchronous and asynchronous work items”, Nov. 15, 2022. The obtaining of the true-to-interval parameter may be performed by capturing the time-interval on which a contact was “Answered” and the time-interval in which the contact handled was “active”.

According to some embodiments of the present disclosure, between previous poll of data and current poll of data, the module for enabling true-to-interval analytics from an ACD application 130a may extract and transform the data as follows. On arrival of a new contact, adding count as received or answered state. When the state of the contact remains unchanged, adding count under either “Active” or “Hold time”, as per the current state of the contact in the data-feed from the ACD application 110a. When the state of the contact in the data-feed is changed from previous state in previous interval of {x} minutes, adding count under “Active” or “Hold time”, as appropriate.

According to some embodiments of the present disclosure, at the end of each time-interval, e.g., 15 minutes, in the one or more time-intervals of a shift-schedule, the module for enabling true-to-interval analytics from an ACD application 130a may calculated the following parameters. The contacts received, by summing all the contacts under contacts with “Received” state, the active contacts, by summing all of the contacts under “Active” state, the total handle-time by summing all the handle-time that the contact has been active and then summing handle-time for all the contacts and the hold-time, by summing the total handle-time for all contacts during the one or more time-intervals of the shift-schedule.

According to some embodiments of the present disclosure, the parameters calculated by the module for enabling true-to-interval analytics from an ACD application 130a for each time-interval of a shift-schedule and the parameters for the shift-schedule may be stored in the tti-database 140a.

According to some embodiments of the present disclosure, the module for enabling true-to-interval analytics from an ACD application 130a may transform the data from the ACD application 110a to align to the true-to-interval paradigm thus enabling the WFM application 150a to implement the true-to-interval paradigm by using the data for automatic generation of forecasts upon which future schedules may be generated for agents in the contact center.

According to some embodiments of the present disclosure, when the WFM application 150a may receive the calculated total handle-time and total hold-time of each time-interval and a total handle-time of one or more shift-schedules from the module for enabling true-to-interval analytics from an ACD application 130a, the WFM application 150a may automatically generate the forecasts for staff requirements for future schedules, based on the parameters, once the true-to-interval data, e.g., calculated total handle-time and total hold-time of each time-interval and a total handle-time of one or more shift-schedules, may be available for shift-schedules and related time-intervals occurred during a preconfigured period, such as a period of 13 weeks.

According to some embodiments of the present disclosure, system 100A may enable true-to-interval analytics from an ACD application 110a by operating the one or more processors 120a to execute the module for enabling analytics from an ACD application 130a, which may calculate total interval-handle-time and total interval-hold-time for each contact for each time-interval in a shift-schedule. During the time-interval, e.g., 15 minutes, every preconfigured interval of {x} minutes in the time-interval, such as two minutes, data-feed from the ACD application 130a may be polled and true-to-interval parameters from the polled data-feed may be obtained and stored in a database, such as tti-database 140a.

According to some embodiments of the present disclosure, the true-to-interval parameters received in the data-feed from the ACD application 110a may include for each contact a state of activity, handle-time duration, and hold-time duration. The state of activity may be one of: (a) ‘received’; (b) ‘answered’; (c) ‘active’; and (d) ‘hold’.

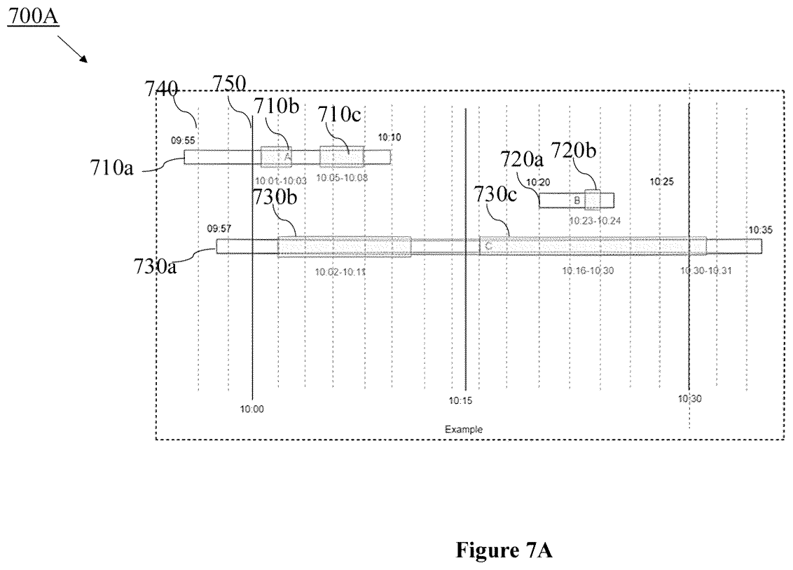

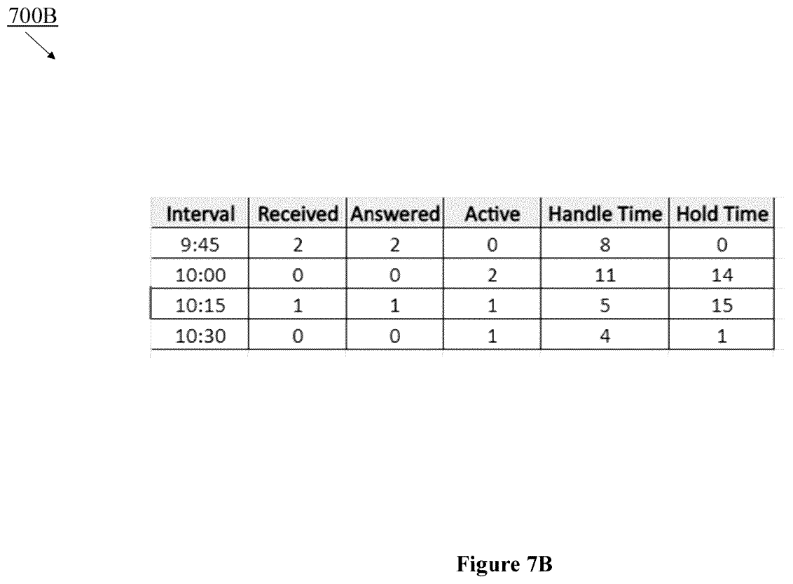

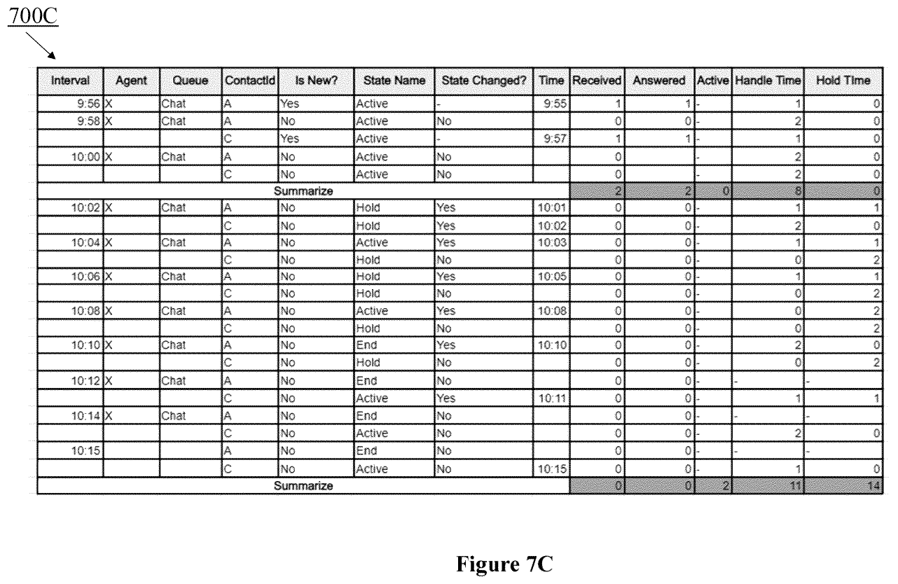

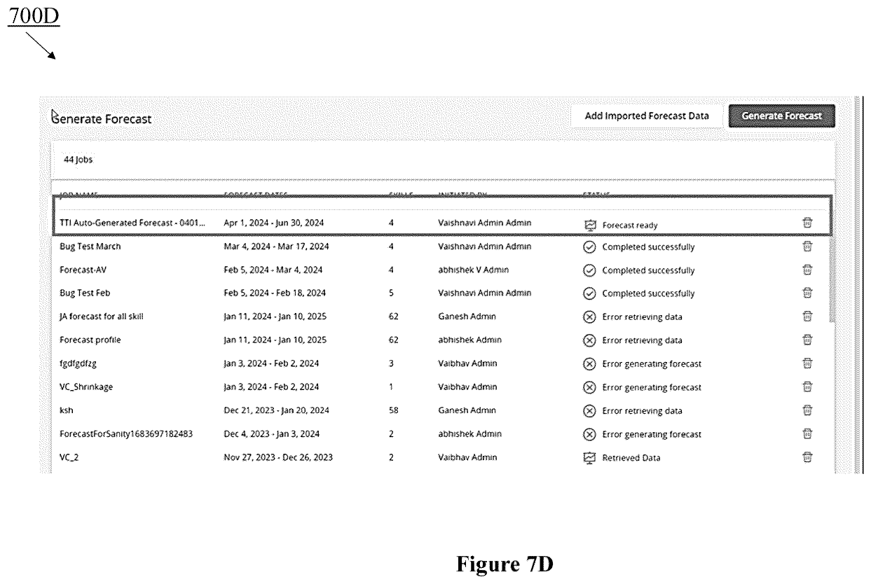

According to some embodiments of the present disclosure, at the end of the time-interval, such as 15 minutes, the number of contacts having the activity state may be calculated, based on the true-to-interval parameters in the tti-database. For example, as shown in table 700B in FIG. 7B and may be stored in the tti-database 140a.

According to some embodiments of the present disclosure, a total handle-time for all contacts during the time-interval may be calculated and stored in the tti-database 140a. For example, as shown in table 700C in FIG. 7C.

According to some embodiments of the present disclosure, the total interval-handle-time for each contact may be calculated based on the duration that the contact had ‘active’ state during the time-interval, and the total interval-hold-time for each contact may be calculated based on the duration that the contact had ‘hold’ state during the time-interval.

According to some embodiments of the present disclosure, after the calculations for all time-intervals in a shift-schedule or for a plurality of shift-schedules, the module for enabling true-to-interval analytics from an ACD application 130a may retrieve the calculated total handle-time and total hold-time of each time-interval and a total handle-time of one or more shift-schedules from the tti-database 140a and may transmit it to a WFM application 150a, over a communication channel to enable the WFM application 150a to implement true-to-interval analytics. For example, staffing requirements and forecasts for future shift-schedules.

According to some embodiments of the present disclosure, the total handle-time of each shift-schedule in the one or more shift-schedules may be calculated by summing the total handle-time for all contacts during the one or more time-intervals of the shift-schedule.

According to some embodiments of the present disclosure, the WFM application 150a may be configured to generate a forecast for a period having one or more future-schedules based on the transmitted total handle-time and total hold-time of each time-interval of the one or more shift-schedules.

According to some embodiments of the present disclosure, the generated forecast for the period may be displayed via a User interface (UI) that is associated to the WFM application and optionally, upon user-click on an icon on the UI, a notification of the generated forecast may be automatically sent to a computerized-device of a user, for review. For example, as shown in table 700D in FIG. 7D.

According to some embodiments of the present disclosure, the forecast for the period may include agents requirement for each future-time-interval in each future-schedule in the one or more future-schedules generated by the WFM application 150a.

According to some embodiments of the present disclosure, the WFM application 150a may be configured to automatically generate a forecast for a period having one or more future-schedules based on the transmitted total handle-time and total hold-time of each time-interval of the one or more shift-schedules and then optionally, based on the generated forecast, automatically schedule agents for the one or more future-schedules in the period.

According to some embodiments of the present disclosure, with the implementation of true-to-interval paradigm by the WFM application 150a, scheduling of shift-schedules may be optimized to match real-time demand of the contact center, leading to improved agent productivity and better service levels. Moreover, the true-to-interval paradigm allows for dynamic resource allocation, ensuring that, based on data history, the right number of agents are available at the right times to handle expected interaction volumes.

According to some embodiments of the present disclosure, the total handle-time and total hold-time of each time-interval and a total handle-time of one or more shift-schedules from the tti-database 140a may be used in intraday management in the WFM application 150a where the count of received, answered and active contacts may be used to monitor the current status of the contact center.

According to some embodiments of the present disclosure, the total handle-time and total hold-time of each time-interval and a total handle-time of one or more shift-schedules from the tti-database 140a may be used by the intraday management in the WFM application 150a to determine staffing requirements for current shift-schedule and automatically operate actions to adjust staffing during the day. For example, adding staffing or reducing staffing during current shift-schedule.

According to some embodiments of the present disclosure, system 100A may provide an accurate representation of long duration synchronous/synchronous work items for the purpose of calculating staffing requirements in advance.

According to some embodiments of the present disclosure, a human is incapable of performing the conversion of non-true-to-interval data to true-to-interval data and to achieve the same results due to extremely large transitory data sets of events and activities associated with a work item, and the need to retain the state of a work item in memory over the course of time to ensure correct accounting of activities that occur for a single work over multiple time intervals.

FIG. 1B schematically illustrates a high-level diagram of a system 100B for enabling true-to-interval analytics from an Automatic Contact Distributor (ACD) application, in accordance with some embodiments of the present invention.

According to some embodiments of the present disclosure, system 100A in FIG. 1A may be implemented in a cloud computing services infrastructure, such as Amazon® Web Services (AWS).

According to some embodiments of the present disclosure, Amazon® Route 53 Resolver, which is a building block of WFM application architecture, responds recursively to DNS queries from AWS resources for public records, Amazon VPC-specific DNS names, and Amazon Route 53 private hosted zones. Nginx is an open-source web server software that can also be used as a reverse proxy, load balancer, email proxy, and HTTP cache.

According to some embodiments of the present disclosure, a Simple Storage Service (Amazon S3, which is a building block of WFM application architecture, is a web-based cloud storage service offered by AWS. It's a scalable, high-speed service designed for online backup and archiving of data and applications. Amazon S3 stores data as objects within buckets. An object is a file and any metadata that describes the file. A bucket is a container for objects.

According to some embodiments of the present disclosure, Amazon CloudFront is a Content Delivery Network (CDN) service operated by AWS. It's designed to provide a globally-distributed network of proxy servers to cache content, such as web videos or other bulky media, more locally to consumers.

According to some embodiments of the present disclosure, Keycloak is an open-source Identity and Access Management (IAM) tool. It's designed to provide Single Sign-On (SSO) access to applications and services. Keycloak allows users to authenticate once and access multiple applications without needing to re-enter their credentials.

According to some embodiments of the present disclosure, Amazon Relational Database Service (RDS) is a web service offered by AWS. It is a managed Structured Query Language (SQL) database service that helps with relational database management tasks, such as data migration, backup, recovery, and patching.

According to some embodiments of the present disclosure, AWS CloudWatch is a monitoring and management service for AWS resources and applications. It collects and tracks metrics that measure your resources and applications. CloudWatch displays the metrics automatically about every chosen AWS service.

According to some embodiments of the present disclosure, Amazon Elastic Container Service (Amazon ECS) is a cloud computing service in AWS that manages containers. It allows developers to run applications in the cloud without having to configure an environment for the code to run in.

According to some embodiments of the present disclosure, EC2 stands for Elastic Compute Cloud. It's a web service that provides secure, resizable compute capacity in the cloud. EC2 is part of AWS. As part of ECS cluster mentioned above, there are the underlying EC2 instances where microservices gets deployed. It is a building block of WFM application architecture.

FIG. 1C schematically illustrates a high-level diagram of a system 100C for enabling true-to-interval analytics from an Automatic Contact Distributor (ACD) application, in accordance with some embodiments of the present invention.

According to some embodiments of the present disclosure, system 100A in FIG. 1A may be implemented in a system, such as system 100C.

According to some embodiments of the present disclosure, a service, such as the forecaster service 120c may provide the forecast call volume and Average Handle Time (AHT) for future dates and generate a staffing plans based on historical data.

According to some embodiments of the present disclosure, the historical data, forecasting and staffing plan chart data may be provided via the UI of the WFM application, such as WFM application 150a in FIG. 1A, as well as create, edit and view of forecasting profiles.

According to some embodiments of the present disclosure, the schedule manager microservice 140c which is part of the WFM application, such as WFM application 150a in FIG. 1A may be configured to store and retrieve schedule data, net staffing data, and all configurations required to generate schedules including daily rules, weekly rules, and activity codes. The intraday manager service 145c may retrieve schedule data from the schedule manager microservice.

According to some embodiments of the present disclosure, a micro-service, such as the Schedule Requests Manager (SRM) micro-service 135c may be part of the WFM application. The SRM micro-service 135c may manage all of the agent-generated Schedule Change Requests (SCR) s, such as adding, editing, getting, approving, and declining SCRs.

According to some embodiments of the present disclosure, upon new or edit of SCR submitting calls, the Schedule Rules Automation micro-service may validate API in order to validate the new or edited request against active auto approval rules. Submitting is disabled if there is a rule which auto decline the request.

According to some embodiments of the present disclosure, the SRM micro-service 135c may be called for saving the agent requests as new schedules, e.g., overwrites the schedule and then sends notifications to managers when requests are created. Notifications may be sent to agents on approval or decline. the data may be stored in RDS.

According to some embodiments of the present disclosure, the Real Time Adherence (RTA) agents states events may calculate the employees' adherence status by comparing the actual activity of the employee, received from the ACD with the expected activity scheduled for the employee that may be received from the schedule-manager micro-service. The agent's state may be in adherence or out of adherence.

According to some embodiments of the present disclosure, the intraday-manager micro-service 145c may be part of WFM applications, such as WFM application 150a in FIG. 1A. It may show all intraday metrics data e.g., actual, forecasted, variance per one skill or multiple skills for a preconfigured period, such as 24 hours' time-range. The forecasted data may be compared with actual data and a variance may be derived determine whether the contact center is understaffed or overstaffed.

According to some embodiments of the present disclosure, the intraday manager micro-service 145c may be part of WFM application and may handle the intraday data and metrics that are part of the dashboard. It may run each preconfigure period of time, e.g., every 15 minutes, and may be triggered by a scheduled task that runs automatically at specified intervals or specific times on a server, e.g., cron job. The intraday manager micro-service 145c may start two jobs: Get Forecast data, such as AHT, Average Speed of Answer (ASA), volume, SLA, staffing from schedule manager, e.g., netsaffing API and save it to a database.

According to some embodiments of the present disclosure, reforecast data may be calculated, e.g., AHT, ASA, Volume, SLA for all tenants with reforecast toggle On. The forecast and reforecast data are presented by the intraday manager micro-service 145c.

According to some embodiments of the present disclosure, system 100c may support receiving Intraday data from an ACD application, such as ACD application 110a in FIG. 1A, such as Cisco Unified Contact Center Express (UCCX) by monitoring a dedicated S3 bucket that the data is written to, normalize and resolve the received data and send it to the kinesis stream.

According to some embodiments of the present disclosure, the time-off-manager micro-service 150c may enable to define time-off rules via the UI of the WFM application, calculate time-off balance for agents and calculate API for automatic time off approval or semi-automatic approval. The time-off-manager micro-service 150c may consider the staffing requirements in the tti-database.

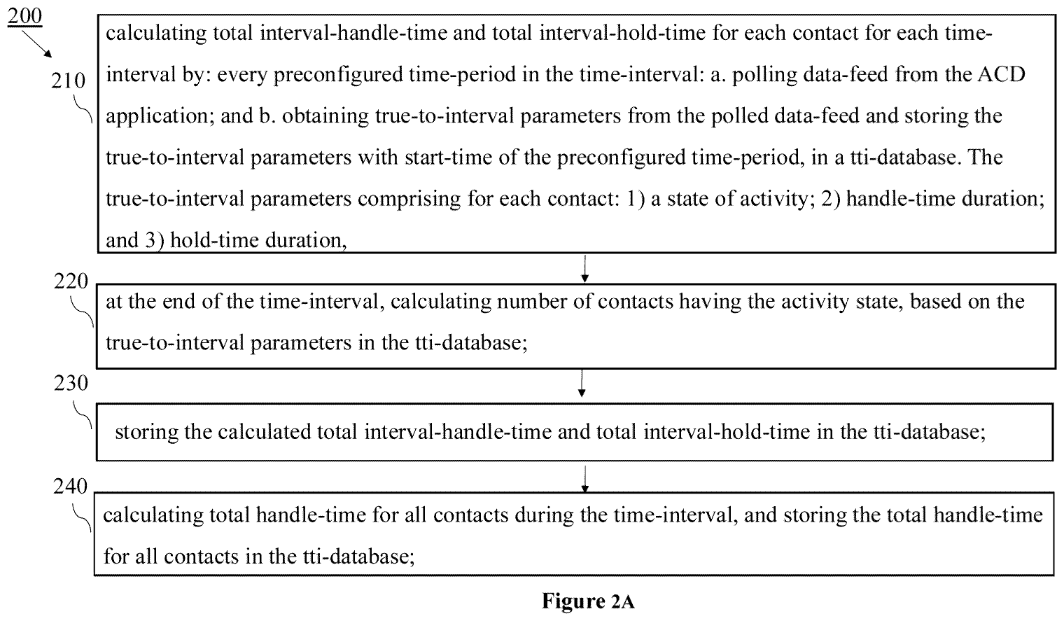

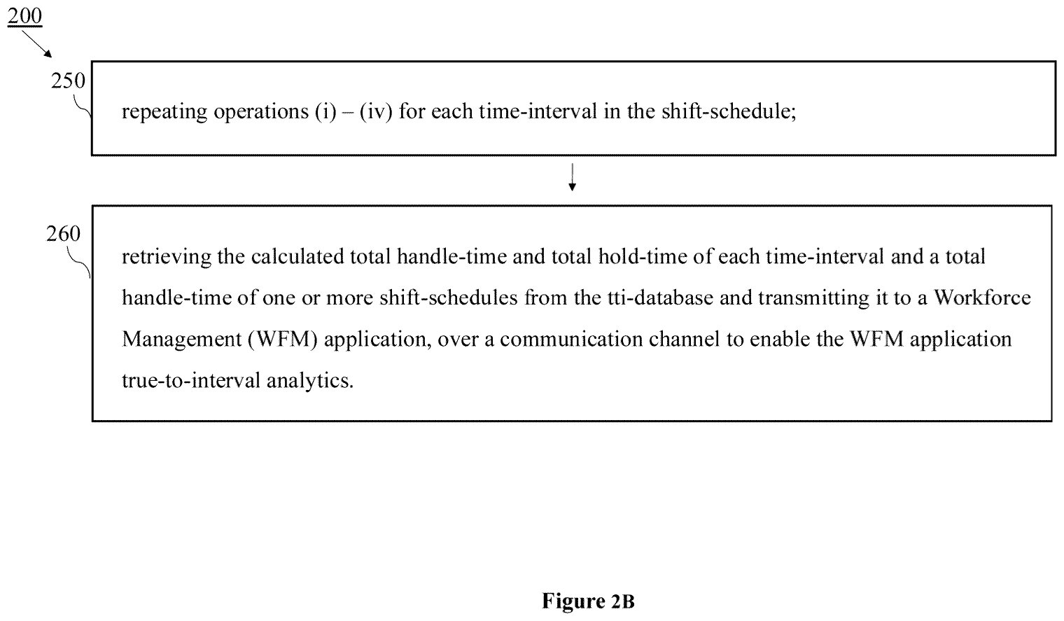

FIGS. 2A-2B schematically illustrate a high-level diagram of a module for enabling true-to-interval analytics from an Automatic Contact Distributor (ACD) application, in accordance with some embodiments of the present invention.

According to some embodiments of the present disclosure, operation 210 comprising calculating total interval-handle-time and total interval-hold-time for each contact for each time-interval by: every preconfigured time-period in the time-interval: a. polling data-feed from the ACD application; and b. obtaining true-to-interval parameters from the polled data-feed and storing the true-to-interval parameters with start-time of the preconfigured time-period, in a tti-database. The true-to-interval parameters comprising for each contact: 1) a state of activity; 2) handle-time duration; and 3) hold-time duration.

According to some embodiments of the present disclosure, operation 220 comprising at the end of the time-interval, calculating number of contacts having the activity state, based on the true-to-interval parameters in the tti-database.

According to some embodiments of the present disclosure, operation 230 comprising storing the calculated total interval-handle-time and total interval-hold-time in the tti-database.

According to some embodiments of the present disclosure, operation 240 comprising calculating total handle-time for all contacts during the time-interval and storing the total handle-time for all contacts in the tti-database.

According to some embodiments of the present disclosure, operation 250 comprising repeating operations (i)-(iv) for each time-interval in the shift-schedule.

According to some embodiments of the present disclosure, operation 260 comprising retrieving the calculated total handle-time and total hold-time of each time-interval and a total handle-time of one or more shift-schedules from the tti-database and transmitting it to a Workforce Management (WFM) application, over a communication channel to enable the WFM application true-to-interval analytics.

According to some embodiments of the present disclosure, for example, the WFM application true-to-interval analytics may be operated by an intraday manager service, such as intraday manager service 145c in FIG. 1c. In another example, the WFM application true-to-interval analytics may be operated by a schedule manager service, such as schedule manager service 140c in FIG. 1C.

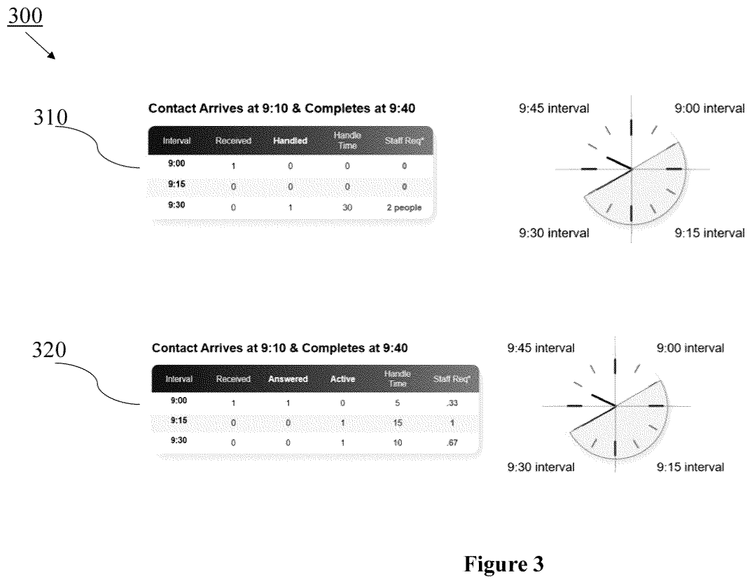

FIG. 3 schematically illustrates a calculation 300 of agents requirements before and after enabling true-to-interval analytics from an Automatic Contact Distributor (ACD) application, in accordance with some embodiments of the present invention.

According to some embodiments of the present disclosure, existing systems use WCE paradigm which calculates the Average Handle Time at the end of the contact. However, a system, such as system 100A, may convert non-true-to-interval data-feed from the ACD application, such as ACD application 110a in FIG. 1A to true-to-interval parameters to enable a WFM application, such as WFM application 150a in FIG. 1A, to implement true-to-interval paradigm. The WFM may implement the true-to-interval paradigm by the calculation of Average Handle Time of a contact when it is actually being actively worked upon based on the total handle-time and total hold-time of each contact in each time-interval.

In screenshot 310, the result of WCE based algorithms is displayed where the algorithms calculate the AHTs when the contact ends. In digital interactions, where the contacts span across multiple time-intervals, the AHT that is calculated at the time-interval of the closure of a contact may provide incorrect information of the contact's overall handle time. This skews the staffing requirements and hence may impact the quality of schedules being generated for the agents.

For example, when an interaction has been received at 9:10, in the time-interval that began at 9:00 but handled at 9:40 in the time-interval that started at 9:30, may indicate handle time of 30 minutes, and staffing requirement of two agents based on 30/15=2.

According to some embodiments of the present disclosure, a system, such as system 100A may transform data-feed from the ACD application to a true-to-interval compatible data which may be transmitted to a WFM application for an automated generation of staff requirements forecasts for future schedules. For example, as shown in screenshot 320.

According to some embodiments of the present disclosure, when the true-to-interval paradigm is implemented the Handle Time of the contact may be calculated for each time-interval the contact has been active. This may provide a more accurate information as to how exactly a contact traverses across multiple intervals and hence, they are considered when calculating their AHTs, thereby generating more accurate staffing requirements and hence better agent schedules.

According to some embodiments of the present disclosure, for example, as shown in table 320, the interaction has arrived at 9:10 and completed at 9:40. The count of received contacts in the time interval that started at 9:00 is one and the total interval-handle-time is 5 minutes and therefore, the staffing requirement for the time-interval may be 5/15=0.33. In the time-interval that started at 9:15 the count of active contacts is one and the total interval-handle-time is 15 minutes and therefore the staffing requirements for the time-interval may be 15/15=1. In the time-interval that started at 9:30 the count of active contacts is one and the handle time is 10 minutes. Therefore, the staffing requirement for the time-interval may be 10/15=0.67.

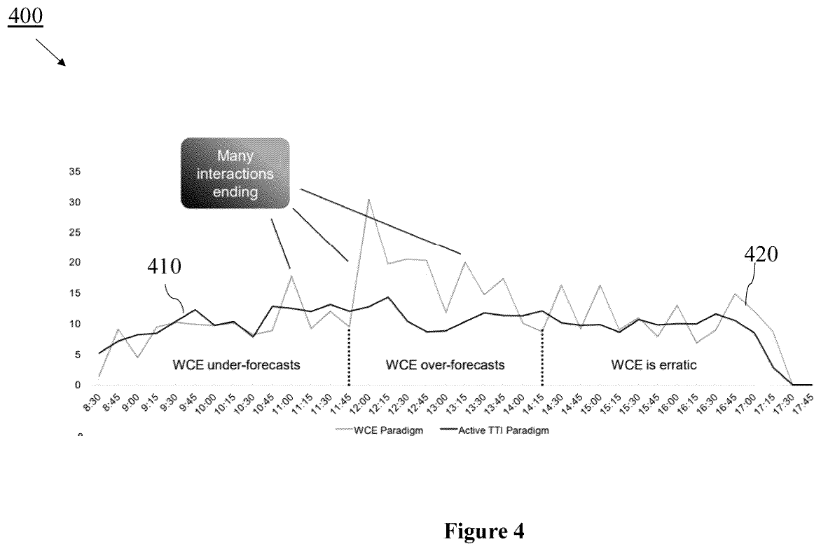

FIG. 4 schematically illustrates a graph 400 of comparison of staff requirements prediction, in accordance with some embodiments of the present invention.

According to some embodiments of the present disclosure, graph 400 is an example that is illustrating a comparison of staffing predictions calculated using the WCE paradigm and TTI paradigm.

According to some embodiments of the present disclosure, line 410 represents staff requirement prediction of work effort required in each time-interval based on true-to-interval paradigm and line 420 represents staff requirement prediction of work effort required in each time-interval based on WCE paradigm.

According to some embodiments of the present disclosure, graph 400 shows that based on WCE paradigm the staffing requirements based on the WCE paradigm may be either under-forecasts or over-forecasts as compared to staffing requirements based on true-to-interval paradigm. The staffing requirements may be also erratic when it is based on WCE calculations instead of smoother when it is based on true-to-interval paradigm.

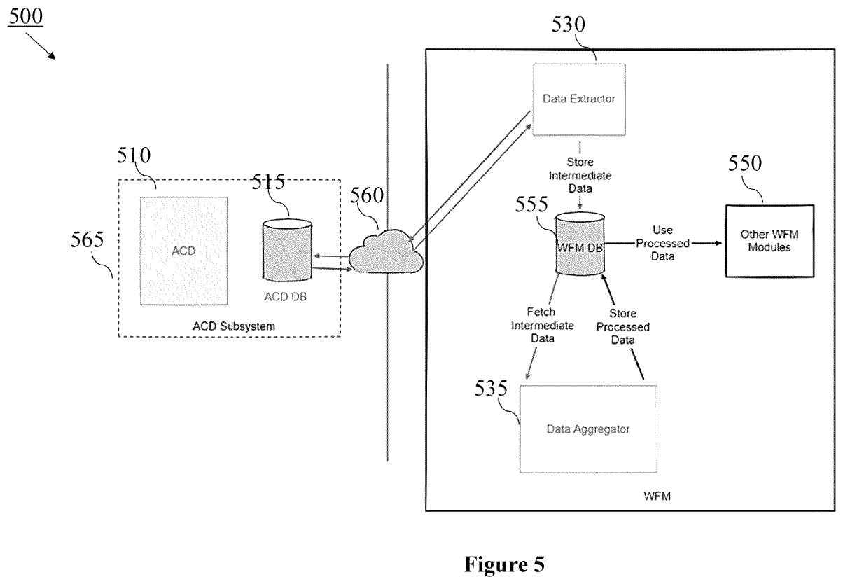

FIG. 5 schematically illustrates extractor and transformer service 500, in accordance with some embodiments of the present invention.

According to some embodiments of the present disclosure, system 100A in FIG. 1A may implement the extractor and transformer service 500, for example, via a module, such as module for enabling true-to-interval analytics from an Automatic ACD application 130a in FIG. 1A.

According to some embodiments of the present disclosure, the extractor and transformer service 500 may perform two tasks. The first task may be taking input from the ACD system 565, such as ACD application 110a in FIG. 1A and building intermediate data. This intermediate data may be stored in the database, such as ACD database 515. After the time-interval, e.g., 15- or 30-minutes ends, the extractor and transformer service 500 may perform the second task of transformation. Under the transformation task, the extractor and transformer service 500 may aggregate the data. The result of the aggregation process may be stored in a database, such as tti-database 140a in FIG. 1A and may be transmitted later on to a WFM application to be used as a building block for the forecaster service.

According to some embodiments of the present disclosure, the data extractor 530 of the extractor and transformer service 500 may fetch the contact information from the ACD system 565 at a pre-defined interval, e.g., 2 minutes and may store the intermediate data in a database, such as WFM database 555.

According to some embodiments of the present disclosure, the data aggregator 535 may fetch the intermediate data from the WFM database 555 at the end of time-every interval, e.g., 15 minutes and may construct the true-to-interval compatible output.

According to some embodiments of the present disclosure, the extractor and transformer service 500 may be hosted as a microservice following the exact same specifications as that of any other microservice. The output of this microservice may be true-to-interval formatted data which may be consumed by the existing microservice, e.g., forecaster batch.

According to some embodiments of the present disclosure, after polling the data from the ACD system 565, the event e.g., agent state, may be either a new event, an agent is in the same state, or the agent has changed the state. The status of the event may be determined by comparing it with the status of all of the events that are stored in the memory of the component.

According to some embodiments of the present disclosure, when the event is new, the event may be marked as new and stored in the memory for future processing. When the event is old then determining if this event is an extension of the old event or if the state of the contact has been changed. If the event is an extension of the old event, i.e., the agent is in the same state as before, then incrementing the elapsed time of that agent in that state by the time that was taken between two polls.

According to some embodiments of the present disclosure, when the agent state has changed between the two polls, then determining that the agent was in the previous state until the agent state is changed. For example, when the agent has spent some time in the previous state, the previous state could be active, i.e., active state is the state in which the agent was performing the active job, such as on-call, handling contact, and the like, or an inactive or hold state. Determining if the previous state was active or inactive and based on this decision, storing the state and other details in the database.

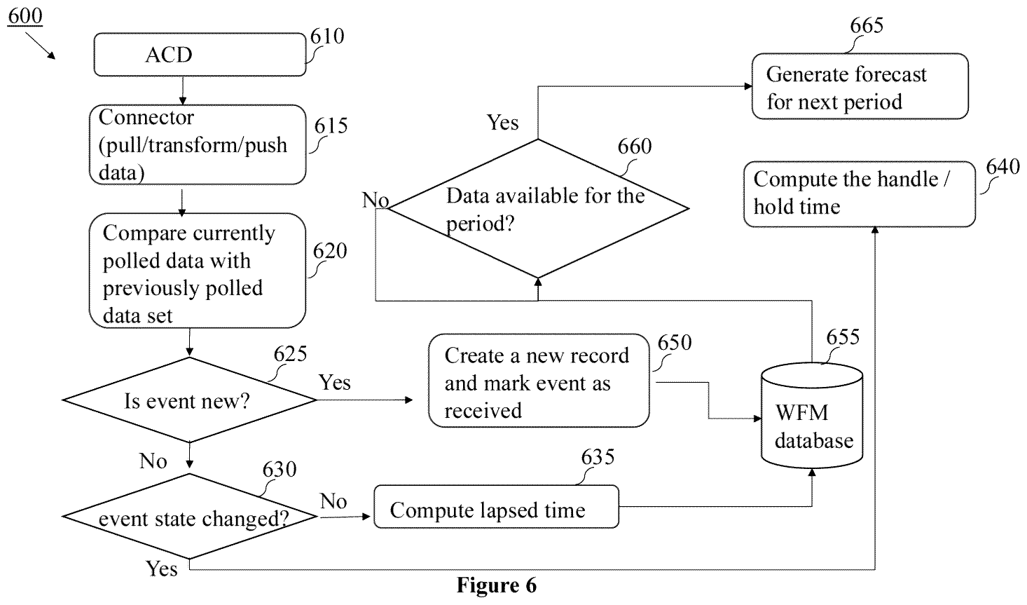

FIG. 6 schematically illustrates a high-level diagram 600 of a computerized-method for enabling true-to-interval analytics from an Automatic Contact Distributor (ACD) application, in accordance with some embodiments of the present invention.

According to some embodiments of the present disclosure, in a system, such as system 100A in FIG. 1A, data may be fetched via a Representational State Transfer (REST) API call or directly from ACD database or calling ACD exposed methods and the like 610 from an ACD application that is integrated with the WFM application via connectors. A Connector 615 is a software which pulls the data from the ACD application, transforms the data based on the consumer application's supported format and pushes it towards the consumer application, e.g., WFM application. This data comprises of agent ID, agent state which indicates the activity being performed by the agent, start time of the agent state, queue, and contact ID.

According to some embodiments of the present disclosure, this agent state data from the ACD application may be fetched at a regular interval of ‘X’ minutes where X is configurable at the tenant level of the contact center as a service software. For example, X=2 minutes.

According to some embodiments of the present disclosure, details of the intermediate data may be as shown for example, in table 700B.

According to some embodiments of the present disclosure, comparing currently polled data with previously polled data set 620, e.g., compare Agent ID and the Contact ID field values from the recently polled data from ACD application with respective field values of the previously polled data which is stored in the in-memory datastore.

According to some embodiments of the present disclosure, checking if the event is new 625. When there is no record of currently polled data for Agent ID and Contact ID in the previously polled data then we would consider the contact to be a new contact and mark this contact as “Received” 650 and its handle-time would be calculated accordingly. This information will be saved to the database, such as WFM database 655.

According to some embodiments of the present disclosure, the data structures that may be used for the comparison of newly arrived data with the existing data may be implemented by hashed data structures like HashMap where the Key of the map will be the contact ID and the value of the map will be a complex object that holds data of the activity state, such as “Received”, “Answered”, “Active”, “Handle Time” and “Hold Time”.

According to some embodiments of the present disclosure, when the older state of the current contact is found in the database, then it would be considered as an existing contact. Then, checking if event state changed 630 and taking the action accordingly. A state change is a change of the agent's state with regards to the contact being handled either from “Active” to “Hold” or vice versa.

According to some embodiments of the present disclosure, when the state of contact is changed, compute the corresponding handle-time or hold-time 640 depending on the state transitioned. Handle time is when the contact is being handled actively and hold time is the time for which the contact has been put on hold by the agent. For example, at 10:00, contact ‘A’ was being handled by the agent and hence it was in “Active” state when the ACD application was polled. At the next poll, after two minutes, at 10:02, with the current poll from ACD application, the same contact ‘A’ is now in “Hold” state e.g., the state change happened at 10:01.

According to some embodiments of the present disclosure, the handle-time of the contact is 1 minute (10:01-10:00). The hold-time of the contact is 1 minute (10:02-10:01)

According to some embodiments of the present disclosure, if the state of the contact is not changed, compute the lapsed time 635 and store it in a database, such as WFM database 655. For example, between 09:56 to 09:58: The previously and the currently polled status of the contact is “Active”. Hence, the handle-time of the contact is two minutes.

According to some embodiments of the present disclosure, all the calculations and intermediate results for each interval in the time-interval may be stored in the database, such as WFM database 655. At the end of each time-interval, e.g., 15 minutes, compute the below parameters and save it in the historical queue report, so that it may be used for forecasting the staffing requirements using the true-to-interval paradigm.

According to some embodiments of the present disclosure, the computed parameters may be, contact received by summing all contacts under the activity state “received”, active contacts by summing all the contacts under “active” state, interval-handle-time by summing the handle-time of all contacts in the time-interval and interval-hold-time by summing the hold-time of all contacts of in the time-interval.

According to some embodiments of the present disclosure, when data is available for the period 660, e.g., period of 13 weeks, then the WFM application may automatically generate forecast for the next period 665.

According to some embodiments of the present disclosure, the automatically generated forecast for the next period may be presented via a UI, such as UI 700D in FIG. 7D. A user, such as a manager may accept the forecast generated, and save it into the WFM database or if the manager may reject the forecast the forecast may be discarded.

FIG. 7A is an example 700A of operation of a module for enabling true-to-interval analytics from an Automatic Contact Distributor (ACD) application, in accordance with some embodiments of the present invention.

According to some embodiments of the present disclosure, the state transition of the contacts e.g., events during the contact handling process. vertical Each vertical dotted line 740 indicates extractor fetching data-feed from the ACD application. Each solid line indicates end of time-interval, such as 15 minutes. The horizontal block, e.g., 710a, 720a, 730a, indicates the entire journey of the contact, e.g., ‘A’, ‘B’ ‘C.’. The filled block over the horizontal block indicates contact on hold.

For example, the contact ‘A’ 710a came into the system at 9:55 AM, the agent worked on it until 10:01 AM. At 10:01 the contact was put on hold for 2 minutes, i.e., till 10:03 710b. After that the contact was resumed until 10:05 then again it was on hold for three minutes until 10:08 710c. Finally, the call was resumed and completed at 10:10.

According to some embodiments of the present disclosure, in another example, in another example, the contact ‘B’ 720a came into the system at 10:20 AM, the agent worked on it until 10:23 AM. At 10:23 the contact was put on hold for 1 minute, i.e., till 10:24 720b. After that the contact was resumed until 10:25. Finally, the call was resumed and completed at 10:25.

According to some embodiments of the present disclosure, in another example, the contact ‘C’ 730a came into the system at 9:57 AM, the agent worked on it until 10:02 AM. At 10:02 the contact was put on hold for 9 minutes, i.e., till 10:011 730b. After that the contact was resumed until 10:16 then again it was on hold for 14 minutes until 10:31 730c. Finally, the call was resumed and completed at 10:35.

According to some embodiments of the present disclosure, the true-to-interval calculation is shown in table 700B in FIG. 7B.

FIG. 7B is an example of operation of a module for enabling true-to-interval analytics from an Automatic Contact Distributor (ACD) application, in accordance with some embodiments of the present invention.

According to some embodiments of the present disclosure, based on diagram 700A in FIG. 7A the data in table 700B shows the count of each state in each time-interval of 15 minutes.

FIG. 7C is an example 700C of operation of a module for enabling true-to-interval analytics from an Automatic Contact Distributor (ACD) application, in accordance with some embodiments of the present invention.

According to some embodiments of the present disclosure, table 700C shows in detail the data of diagram 700A in FIG. 7A for each interval of two minutes for agent ‘x’ and the calculation for each time-interval e.g., 9:45 and 10:00, of interval-handle-time and interval-hold-time for each contact ‘A’, ‘B’ and ‘C’.

According to some embodiments of the present disclosure, as the details of every interval of two minutes have been captured at the end of every time-interval of 15 minutes, there is a summary of the details that have been captured so far and those details may be stored in a database, such as tti-database 140a in FIG. 1A, so that the forecasting algorithm of the WFM application may utilize the details.

According to some embodiments of the present disclosure, during the summarization phase, summation of all the contacts under “Contacts Received” may yield the received contacts, the summation of all the contacts under “Active” state may yield the active contacts. The summation of

“Handle Time” of all contacts may yield the interval-handle-time and the summation of hold-time of all contacts may yield the interval-hold-time.

FIG. 7D is an example 700D of UI for the result of the operation of a module for enabling true-to-interval analytics from an Automatic Contact Distributor (ACD) application, in accordance with some embodiments of the present invention.

According to some embodiments of the present disclosure, after the data from the ACD application may be processed to true-to-interval specific format, after a preconfigured period of time, such as 13 weeks, a forecast may be autogenerated by the WFM application, such as WFM application 150a in FIG. 1A, using the true-to-interval paradigm for review of a user, such as a manager.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for enabling true-to-interval analytics from an Automatic Contact Distributor (ACD) application, said computerized-method comprising:
during a shift-schedule having one or more time-intervals,
(i) calculating total interval-handle-time and total interval-hold-time for each contact for each time-interval by:
every preconfigured time-period in the time-interval:
a. polling data-feed from the ACD application; and
b. obtaining true-to-interval parameters from the polled data-feed, and storing the true-to-interval parameters with start-time of the preconfigured time-period, in a tti-database,
wherein the true-to-interval parameters comprising for each contact:
1. a state of activity; 2) handle-time duration; and 3) hold-time duration,
(ii) at the end of the time-interval, calculating number of contacts having the activity state, based on the true-to-interval parameters in the tti-database;
(iii) storing the calculated total interval-handle-time and total interval-hold-time in the tti-database;
(iv) calculating a total handle-time for all contacts during the time-interval, and storing the total handle-time for all contacts in the tti-database;
(v) repeating operations (i)-(iv) for each time-interval in the shift-schedule; and
(vi) retrieving the calculated total handle-time and total hold-time of each time-interval and a total handle-time of one or more shift-schedules from the tti-database and transmitting it to a Workforce Management (WFM) application, over a communication channel to enable the WFM application true-to-interval analytics.

2. The computerized-method of claim 1, wherein the state of activity is at least one of: (a) ‘received’; (b) ‘answered’; (c) ‘active’; and (d) ‘hold’.

3. The computerized-method of claim 2, wherein the total interval-handle-time for each contact is calculated by summing one or more preconfigured time-periods in the time-interval that the contact is in ‘active’ state, and wherein the total interval-hold-time for each contact is calculated by summing one or more preconfigured time-periods in the time-interval that the contact is in ‘hold’ state.

4. The computerized-method of claim 3, wherein the total handle-time of each shift-schedule in the one or more shift-schedules is calculated by summing the total handle-time for all contacts during the one or more time-intervals of the shift-schedule.

5. The computerized-method of claim 1, wherein said computerized-method is further comprising:
configuring a Workforce Management (WFM) application to generate a forecast for a period having one or more future-schedules base on the transmitted total handle-time and total hold-time of each time-interval and the total handle-time for each contact of one or more shift-schedules.

6. The computerized-method of claim 5, wherein the computerized-method further comprising displaying the generated forecast for the period via a User interface (UI) that is associated to the WFM application and upon user-click on an icon on the UI, automatically sending a notification of the generated forecast to a computerized-device of a user, for review.

7. The computerized-method of claim 5, wherein the forecast for the period includes agents requirement for each future-time-interval in each future-schedule in the one or more future-schedules.
